(19) United States
(12) Patent Application Publication
(10) Pub. No.: US 2003/0097797 A1
(43) Pub. Date: May 29, 2003

(54) Door module

(76) Inventors: Salvatore Cucchiara, (US); Thomas Dreis, (US); Ludger B. Meyenbrock, (US); Klaus Freitag, (US)

Correspondence Address: CHARLES K. VEENSTRA, DELPHI TECHNOLOGIES, INC., Legal Staff, Mail Code: 480-414-420, P.O. Box 5052, Troy, MI, 48007-5052, US

(21) Appl. No.: 10/301,761

(22) Filed: Nov. 21, 2002

(30) Foreign Application Priority Data
Nov. 26, 2001 (DE) 10157894.6

(51) Int. Cl. B60J 5/04

(52) U.S. Cl. 49/502

(57) ABSTRACT

The invention relates to a door module comprising a plate which can be placed onto an opening, in particular of a sheet metal door panel of a motor vehicle door, and at which a window regulation device is held.

### TECHNICAL FIELD

The invention relates to a door module having a plate which can be placed onto an opening, in particular of a sheet metal door panel of a motor vehicle door, and which, when in place, covers the opening at least predominantly and on which a window regulation device is held.

### BACKGROUND OF THE INVENTION

Such door modules are generally known. The door modules are typically pre-installed at a pre-installation site, subsequently transported to an end-installation site and there attached to a motor vehicle door at a later time.

### SUMMARY OF THE INVENTION

The underlying object of the invention is to provide a door module in which both the transport and the final installation is simplified.

A door module comprising the features of claim 1 is provided to satisfy this object.

A door module in accordance with the invention has a plate which can be placed onto an opening, in particular of a sheet metal door panel of a motor vehicle door, and which, when in place, covers the opening at least predominantly, with a window regulation device, which can be adjusted between a pre-installation position and an end position, being held at one side of the plate and with at least one access opening being provided in the plate such that the window regulation device can be adjusted through the plate from the other side of the plate when the plate is in place.

In accordance with the invention, the window regulation device can be adjusted between a pre-installation position and an end position. In this connection, the pre-installation position of the window regulation device can be selected such that it is particularly favorable for the transport of the door module, i.e. for example such that the window regulation device does not project beyond the edge of the plate at any point. The door module in accordance with the invention can therefore be packed in a particularly compact manner and can be transported in a place saving manner.

The window regulation device is only brought into its end position at the end installation of the door module in accordance with the invention. In this connection, the door module can be placed onto the opening of a sheet metal door panel of a motor vehicle door such that the window regulation device faces into the inside of an inner space of a door. Since the plate covers the opening at least predominantly when in place, at least one access opening is provided in the plate in accordance with the invention through which the window regulation device can be adjusted from the other side, i.e. from the outside.

By means of this access opening, the window regulation device can engage, for example, in the region of a pivot point and pivot from its pre-installation position into its end position. The access aperture proves to be advantageous in particular when the plate completely covers the opening of the sheet metal door panel and an access to the window regulation device through the opening of the sheet metal door panel is not possible at all or only with the aid of special tools.

If, furthermore, additional access openings are provided in the plate of the door module, then a window pane to be moved can also be connected from the outside to a movable carriage of the window regulation device.

If a door latching apparatus is also attached to the side of the plate of the door module facing into the interior space of the door, then this can likewise be activated from the outside through one or more correspondingly arranged access openings when the plate is in place.

In this connection, the access openings in accordance with the invention can be made so small that a correspondingly provided tool, for example a screwdriver, can easily be guided through, but the access openings at the same time can be closed with simple means, for example with small sealing rubbers or with self-adhesive film sections. If the plate of the door module also sits in a sealing manner on an edge region of the sheet metal door panel surrounding the opening, then the passenger compartment of the motor vehicle can be protected particularly effectively against external influences, in particular against moisture or noise penetrating from the outside, by the door module in accordance with the invention.

Advantageous embodiments of the invention can be seen from the dependent claims, from the description and from the drawing.

In accordance with an advantageous embodiment of the door module in accordance with the invention, the window regulation device can be pivoted about a pivot point and the access opening can be arranged in the region of the pivot point. A rotation of the window regulation device means a particularly simple possibility to adjust the window regulation device between its pre-installation position and its end position. In this connection, the adjustment can be achieved by means of a single access opening when the access opening is arranged in the region of the pivot point.

The position of a rail of the window regulation device is preferably oriented in the pre-installation position obliquely to this position in the end position. To facilitate the packing and the transport of the door module, the oblique pre-installation position can be selected in this connection such that the window regulation device does not protrude beyond the edge of the plate in any position. This can in particular be the case when a rail of the window regulation device is oriented in the pre-installation position parallel to a diagonal of the plate.

End sections of the rail advantageously project beyond the plate in the end position. In this way, the end sections in the end position can engage behind an edge region of the sheet metal door panel surrounding the opening and hold the door module in a self-clamping manner at the sheet metal door panel.

At least one further access opening is preferably provided to connect the window regulation device with a window pane. A carriage which can be moved on a rail of the window regulation device can thereby be connected, for example screwed, to the window pane from the outside when the plate is in place.

In accordance with a further embodiment of the invention, a door latching device is provided at the one side of the plate and at least one access opening arranged in the region of the door latching device to actuate the door latching device when the plate is in place.

The or each access opening advantageously respectively has an area in the range of a few square centimeters. In that the access openings are made particularly small in accordance with the invention, they can be closed easily with simple means, for example with sealing rubbers or self-adhesive film sections.

Furthermore, it is particularly favorable for the plate to be a sealing plate which sealingly covers the opening. The passenger compartment can then be protected particularly easily against external influences, in particular against penetrating moisture or noise.

A further object of the invention is a method of installing a window regulation device in an inner space of a door of a motor vehicle door bounded by a sheet metal door panel in which the window regulation device is attached in a pre-installation position to a plate, the plate is placed onto an opening provided in the sheet metal door panel such that the window regulation device faces into the interior space of the door and the window regulation device is brought into an end position from the outside through at least one access opening provided in the plate and the window regulation device is connected to at least one window pane from the outside through the and/or at least through one further access opening. The already explained advantages in the transport and in the installation of a door module in accordance with the invention can be achieved by the method in accordance with the invention.

The in place plate is preferably fixed in place at the sheet metal door panel, and in particular clamped to the sheet metal door panel, in the end position of the window regulation device by a rail of the window regulation device engaging behind the edge region of the sheet metal door panel bounding the opening. This self-clamping of the plate to the sheet metal door panel facilitates a securing of the plate to the motor vehicle door.

The opening is advantageously sealingly closed by the in place plate and the or each access opening of the plate is closed with a sealing material. In this manner, the passenger compartment can be particularly easily protected against external influences, in particular against penetrating moisture and noise.

### BRIEF DESCRIPTION OF THE DRAWINGS

The invention will be described purely by way of example in the following with reference to an advantageous embodiment and to the drawing. There are shown:

FIG. 1 is a door module in accordance with the invention in a pre-installation state; and

FIG. 2 is an exploded presentation of the door module in FIG. 1 in an end installation state.

### DESCRIPTION OF THE PREFERRED EMBODIMENT

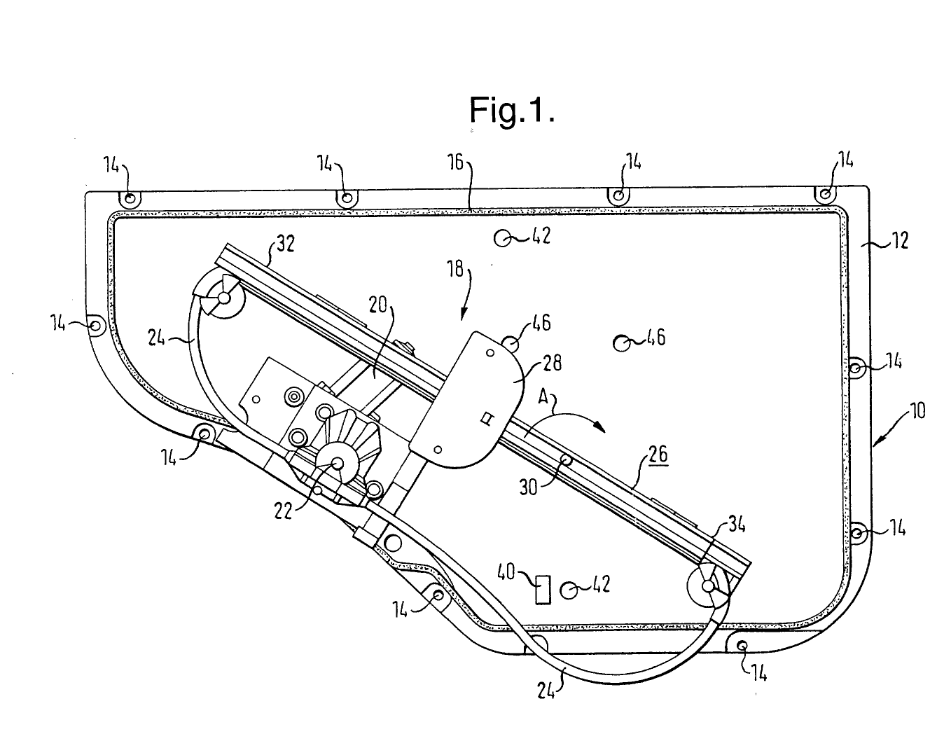

FIG. 1 shows a door module in accordance with the invention in a pre-installation state. The door module includes a plate 10 which is formed from a non-transparent material, for example from an injection molded plastic. The plate 10 can be placed onto an opening (not shown) of a sheet metal door panel of a motor vehicle door—in the example represented of a right hand motor vehicle door. In this connection, the outline of the plate is matched to the shape of the opening such that, when in place, the plate 10 covers the opening and an edge region of the sheet metal door panel of the motor vehicle door bounding the opening.

Bores 14 are provided along an edge region 12 of the plate 10 overlapping the edge region of the sheet metal door panel when the plate is in place to screw the door module to the sheet metal door panel of the motor vehicle door. So that the plate 10 sealingly covers the opening of the sheet metal door panel, a sealing strip 16 of an elastically deformable material, for example, a rubber sealing lip, moreover extends along the whole edge region 12 of the plate 10.

A window regulation device 18 is held on the plate 10. The window regulation device 18 includes a drive unit which has a drive motor 20, a transmission unit 22 and a Bowden cable guide 24. Bowden cables (not shown) guided in the Bowden cable guide connect the drive motor 20 via the transmission unit 22 to a carriage 28 forcibly guided in a rail 26 so that the former can be moved along the rail 26 by the drive motor 20. The carriage 28 serves for the securing of a window pane (not shown) to move the latter by the drive motor 20 and thus to be able to open or close a window of the motor vehicle door automatically.

In the pre-installation state, the rail 26 of the window regulation device 18 is oriented approximately parallel to a diagonal of the plate 10 extending between two oppositely disposed corners of the plate 10. In this pre-installation position, substantially no part of the window regulation device 18 projects beyond the plate 10. In particular, no sections of the rail 26 project beyond the edge of the plate 10. Only the Bowden cable guide 24 regionally extends beyond the plate 10. Since, however, the Bowden cable guide 24 is made flexible, it can optionally be bent for a transport of the door module and fixed on the plate 10 such that it also does not project beyond the edge of the plate 10.

The window regulation device 18 is rotationally supported on the plate 10 about a pivot point 30. The pivot point 30 is disposed on the plate 10 in a region which divides an upper and a lower, as well as a left hand and a right hand, region of the plate 10 approximately in a ratio of 2:1. At the window regulation device 18, the pivot point 30 is arranged in a region of the rail 26 such that the rail 26 is divided into an upper section 32 and a lower section 34 with a longitudinal ratio of approximately 2:1. To adjust the window device 18 from its pre-installation position into its end position, the window regulation device 18 is turned so far in direction A about the pivot point 30 until the rail 26 is oriented substantially perpendicular to an upper edge of the plate 10, preferably vertically, and in particular in the displacement direction of a window pane (not shown).

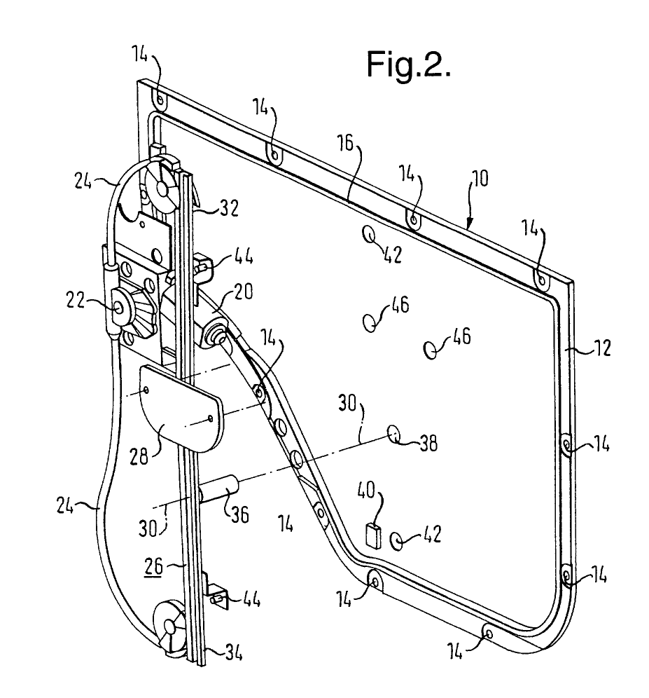

As is shown in FIG. 2, a support pin 36 facing the plate 10 is provided in the region of the pivot point 30 at the rail 26 and is supported in a bore 38 of the plate 10 provided for this purpose to hold the window regulation device 18 at the plate 10.

The bore 38 at the same time serves as an access opening and allows an engaging of the support pin 38 from the side of the plate 10 remote from the window regulation device 18. In this manner, the window regulation device 18 can be set upright from outside the interior passage of the door when the plate 10 is in place.

A stop projection 40 is provided in a lower region of the plate 10 and the rail 26 of the window regulation device 18 abuts it in its end position. In the region of the abutment projection 40 and in an upper region of the plate 10, a respective bore 42 is provided to fix, for example to screw, the window regulation device 18 in its end position to the plate 10 by means of securing member 44 provided at the rail 26.

Furthermore, the plate 10 has two access openings 46 which allow the insertion of a tool, for example of a screwdriver, to connect, for example to screw, the window pane to the carriage 28.

The installation of a door module in accordance with the invention will be described in the following: after the preparation of the plate 10 and of the window regulation device 18, the latter is first held in a pre-installation position on the plate 10 by means of the support pin engaging into the bore 38 of the plate 10, with the rail 26 being oriented substantially parallel to a diagonal of the plate 10 so that the window regulation device 18 does not project beyond the plate 10.

After a transport of the door module to the site of the end installation, the door module is placed with its side on which the window regulation device 18 is arranged onto the opening of the sheet metal door panel of the motor vehicle door, with the opening being completely covered by the plate 10. The window regulation device 18 now faces into the interior of the motor vehicle door. The plate 10 is secured, for example screwed, to the sheet metal door panel through the bores 14.

A suitable tool is subsequently brought into engagement with the support pin 36 supported in the access opening 38. The window regulation device 18 is set upright into its end position in which the rail 26 is oriented in the displacement direction of the window pane, i.e. substantially vertically, from outside by a turning of the tool in direction A about the pivot point 30. In the case of a non-transparent plate 10—as in the example shown—the window regulation device 18 is consequently set upright into its end position from its pre-installation position “blind”.

In the end position, the end sections of the rail 26 each engage behind an edge region of the door plane, whereby the plate 10 is additionally clamped to the sheet metal door panel. To ensure an exact position of the rail 26, the rail 26 abuts the abutment projection 40. The window regulation device 18 is fixed in its end position through the bores 42.

The connection, for example the screwing, of the carriage 28 to the window pane takes place through the access openings 46. Finally, the bores 42 and the access openings 38, 46 are closed by a sealing medium, for example by sealing rubbers or self-adhesive film sections to effectively protect the passenger compartment against external influences, in particular against penetrating moisture and noise.

The access openings 38, 46 allow the plate 10 to be designed such that it completely covers the opening of the sheet metal door panel of the motor vehicle door since both the window regulation device 18 and the carriage 28 can be adjusted from the pre-installation position into the end position and/or connected to the window pane through the access openings 38, 46 from outside the interior space of the door, i.e. from the side of the plate 10 remote from the window regulation device 18. A door latching device arranged at the side of the plate 10 facing toward the interior space of the door can optionally be actuated from the outside through one or more additional access openings.

1. A door module comprising a plate (10) which can be placed onto an opening, in particular of a sheet metal door panel of a motor vehicle door, and which, when in place, covers the opening at least predominantly, with a window regulation device (18) adjustable between a pre-installation position and an end position being held at one side of the plate and with at least one access opening (38, 46) being provided in the plate (10) such that, with the plate (10) in place, the window regulation device (18) can be adjusted through the plate (10) from the other side of the plate (10).

2. A door module in accordance with claim 1, characterized in that the window regulation device (18) can be rotated about a pivot point (30) and the access opening (38) is arranged in the region of the pivot point (30).

3. A door module in accordance with claim 1 or claim 2, characterized in that the position of a rail (26) of the window regulation device (18) is oriented in the pre-installation position obliquely to its position in the end position.

4. A door module in accordance with claim 3, characterized in that end sections of the rail (26) project beyond the plate (10) in the end position.

5. A door module in accordance with any one of the preceding claims, characterized in that at least one further access opening (46) is provided to connect the window regulation device (18) to a window pane.

6. A door module in accordance with any one of the preceding claims, characterized in that a door latching device is provided at the one side of the plate (10), and at least one access opening arranged in the region of the door latching device is provided for actuating the door latching device when the plate (10) is in place.

7. A door module in accordance with any one of the preceding claims, characterized in that the or each access opening (38, 46) each has an area in the range of a few square centimeters.

8. A door module in accordance with any one of the preceding claims, characterized in that the plate (10) is a sealing plate which sealingly covers the opening.

9. A door module in accordance with any one of the preceding claims, characterized in that the plate (10) is not transparent.

10. A method of installing a window regulation device (18) in an interior space of a door of a motor vehicle door bounded by a sheet metal door panel, wherein
the window regulation device (18) is attached to a plate (10) in a pre-installation position;
the plate (10) is placed onto an opening provided in the sheet metal door panel such that the window regulation device (18) faces into the interior space of the door;
the window regulation device (18) is brought into an end position from the outside through at least one access opening (38) provided in the plate (10); and
the window regulation device (18) is connected to at least one window pane from the outside through the and/or at least one further access opening (46).

11. A method in accordance with claim 10, characterized in that the in place plate (10) is fixed to the sheet metal door panel, and in particular clamped to the sheet metal door panel, in the end position of the window regulation device (18) by a rail (26) of the window regulation device (18), with the rail (26) engaging behind an edge region of the sheet metal door panel bounding the opening.

12. A method in accordance with claim 10 or claim 11, characterized in that the opening is sealingly closed by the in place plate (10) and the or each access opening (38, 46) of the plate (10) is closed by a sealing material.
